(19) United States
(12) Patent Application Publication
(10) Pub. No.: US 2025/0058484 A1
(43) Pub. Date: Feb. 20, 2025

(54) ELECTRIC SHAVER

(71) Applicant: CONAIR LLC, Stamford, CT (US)

(72) Inventors: Vito James CARLUCCI, Stratford, CT (US); Dennis J. COLPITTS, Fairfield, CT (US)

(73) Assignee: CONAIR LLC, Stamford, CT (US)

(21) Appl. No.: 18/450,697

(22) Filed: Aug. 16, 2023

(51) Int. Cl. B26B 19/02; B26B 19/38

(52) U.S. Cl. CPC B26B 19/02; B26B 19/382; B26B 19/3873

(57) ABSTRACT

There is provided an electric shaver having (a) a main body that includes a shaver head and a first pair of contacts through which a first voltage is provided, and (b) a cap that is installable on the main body in a first orientation or a second orientation, and when installed on the main body covers the shaver head. The cap has (1) a second pair of contacts that engage the first pair of contacts when the cap is installed on the main body, to receive the first voltage, and (2) a circuit having (i) a diode bridge that receives the first voltage via the second pair of contacts, and provides a second voltage of proper polarity for utilization by other components of the circuit, and (ii) an ultraviolet (UV) light source that utilizes the second voltage, and when ON, emits UV light that irradiates the shaver head.

### BACKGROUND

### 1. Field of the Invention

The present disclosure is related to an electric shaver, and more particularly, an electric shaver that has a shaver head and includes components for disinfecting the shaver head.

### 2. Description of Related Art

An electric shaver includes a shaver head that may become contaminated with bacteria.

Accordingly, there is a need for an electric shaver having a capability to disinfect the shaver head.

### SUMMARY

There is provided an electric shaver having the capability to disinfect the shaver head.

There is also provided an electric shaver having (a) a main body that includes a shaver head and a first pair of contacts through which a first voltage is provided, and (b) a cap that is installable on the main body in a first orientation or a second orientation, and when installed on the main body covers the shaver head. The cap has (1) a second pair of contacts that engage the first pair of contacts when the cap is installed on the main body, to receive the first voltage, and (2) a circuit having (i) a diode bridge that receives the first voltage via the second pair of contacts, and provides a second voltage of proper polarity for utilization by other components of the circuit, and (ii) an ultraviolet (UV) light source that utilizes the second voltage, and when ON, emits UV light that irradiates the shaver head.

### DESCRIPTION OF THE DRAWINGS

FIG. 1 is a diagram of an electric shaver.

FIG. 2 is a diagram of a main body of the shaver of FIG. 1.

FIG. 3 is a cross section of a top portion of the electric shaver of FIG. 1.

FIG. 4 is a cross section along the length of the electric shaver of FIG. 1.

FIG. 5 is an exploded view of a cap of the shaver of FIG. 1.

FIG. 6 is another exploded view of the cap of the shaver of FIG. 1.

FIG. 7 is a schematic diagram of a circuit in the shaver of FIG. 1.

FIG. 8 is a diagram showing two examples of the cap of the shaver of FIG. 1 installed on main body of the shaver.

### DETAILED DESCRIPTION

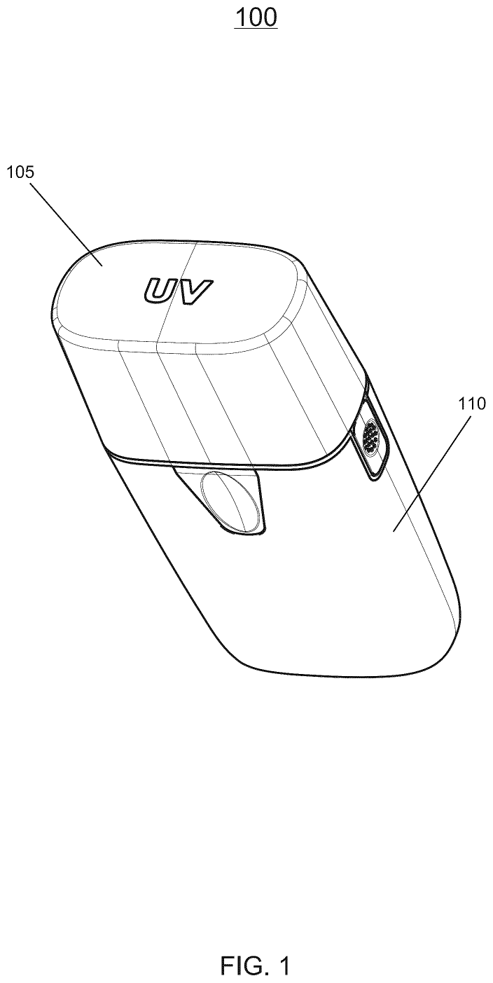

FIG. 1 is a diagram of an electric shaver, namely shaver 100, that has a main body 110 and a cap 105. Cap 105 is removable from main body 110.

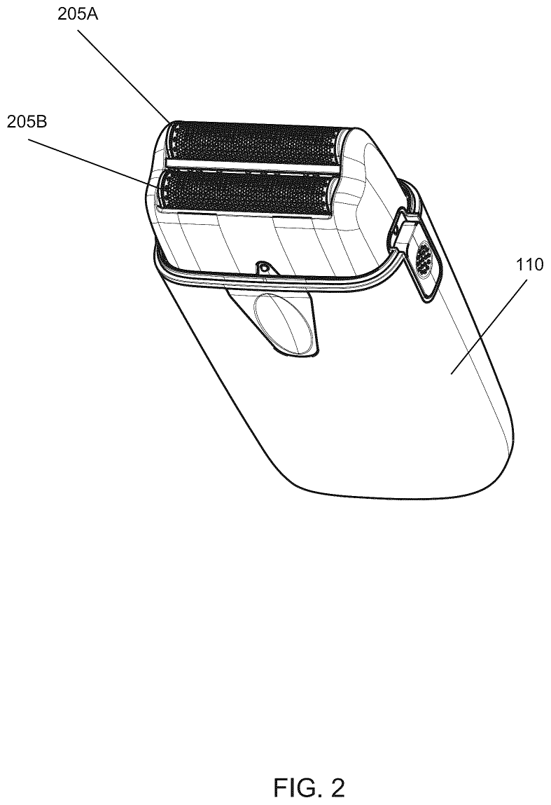

FIG. 2 is a diagram of main body 110. Cap 105 has been removed, thus revealing two shaver heads 205A and 205B that are parts of main body 110. Shaver heads 205A and 205B can be fabricated as foil shaver heads.

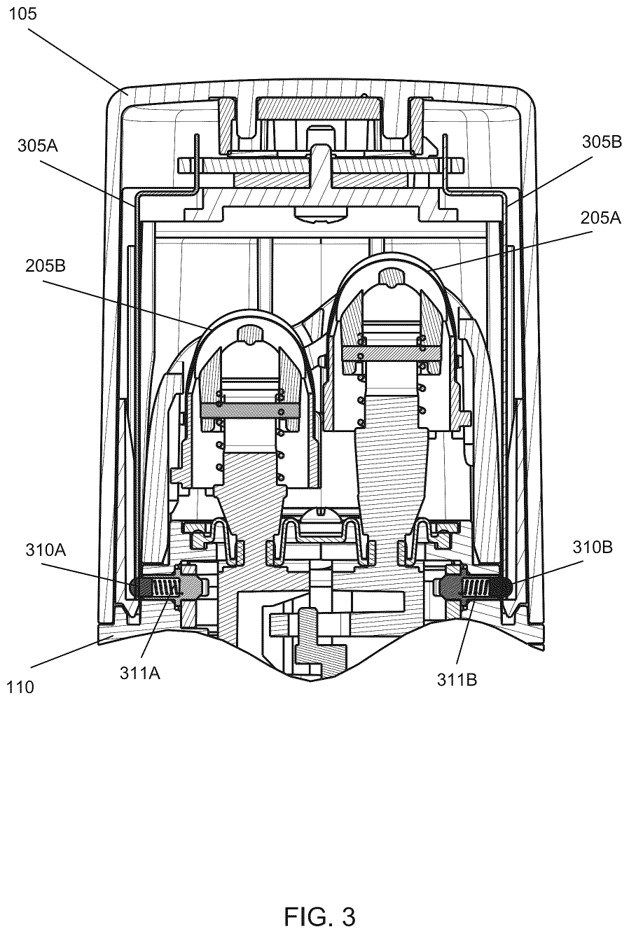

FIG. 3 is a cross section of a top portion of shaver 100, showing parts of cap 105 and main body 110. Here, cap 105 is installed on main body 110, and thus covers and protects shaver heads 205A and 205B.

Main body 110 includes a pair of contacts, namely spring-loaded contacts 310A and 310B. Cap 105 includes a pair of contacts, namely contact bars 305A and 305B, which extend along sides within cap 105 to a point where they can make contact with spring-loaded contacts 310A and 310B. Thus, when cap 105 is installed on main body 110, as shown in FIG. 3, spring-loaded contacts 310A and 310B exert a mechanical force toward contact bars 305A and 305B, respectively. Spring-loaded contacts 310A and 310B and contact bars 305A and 305B are electrical conductors. Springs 311A and 311B bias spring-loaded contacts 310A and 310B outward from main body 110.

Spring-loaded contacts 310A and 310B are self-wiping. This self-wiping action removes or reduces build-up of shaving debris and cleaning solutions from spring-loaded contacts 310A and 310B. Self-wiping is achieved when cap 105 is installed on main body 110 or removed from main body 110. In either instance, cap 105 is moved in a direction toward or away from main body 110 along a direction generally perpendicular to springs 311A and 311B that bias spring-loaded contacts 310A and 310B, so that the contact bars 305A and 305B also move along with cap 105. During such movement, contact bars 305A and 305B are engaged and disengaged by spring-loaded contacts 310A and 310B and, during such engagement, a physical wiping action occurs between contact bars 305A and 305B and the spring-loaded contacts 310A and 310B.

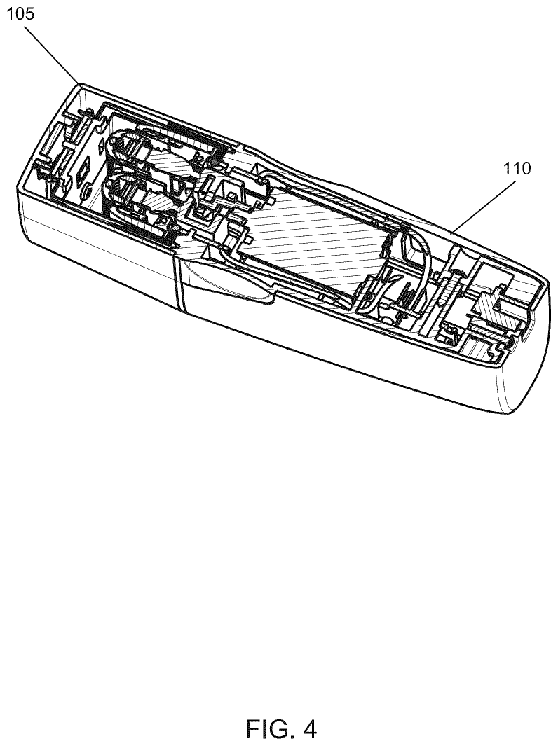

FIG. 4 is a cross section along the length of shaver 100, showing parts of cap 105 and main body 110. Main body 110 includes a motor drive system and a battery.

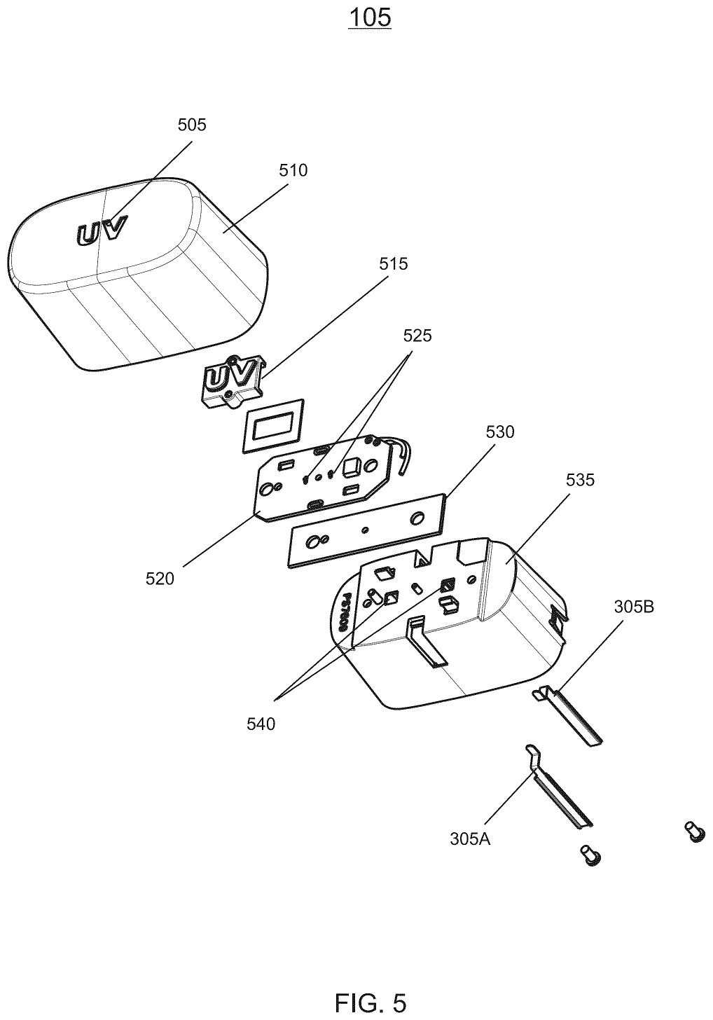

FIG. 5 is an exploded view of cap 105. Cap 105 is configured with an inner shell 535 and an outer shell 510. Inner shell 535 is made of a non-conductive material, for example, plastic. Outer shell 510 is made of a metallic material. In a space between inner shell 535 and outer shell 510, there is an indicator light diffuser 515, a circuit board 520 and a circuit board 530. When cap 105 is assembled, circuit boards 520 and 530 are electrically coupled to one another.

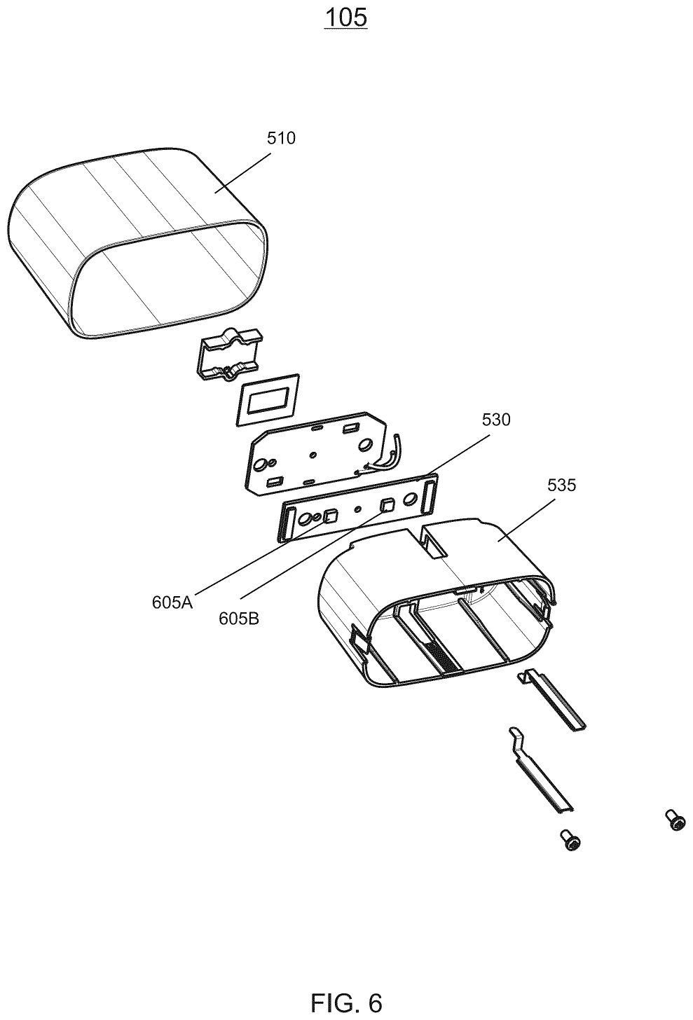

FIG. 6 is another exploded view of cap 105, showing that circuit board 530 includes ultraviolet (UV) light sources 605A and 605B.

Referring again to FIG. 5, inner shell 535 includes apertures 540 that accommodate UV light sources 605A and 605B, and as such, UV light sources 605A and 605B are directed downward, i.e., into inner shell 535. UV light is known to have a disinfecting capability. When cap 105 is installed on main body 110, and UV light sources 605A and 605B are ON, UV light sources 605A and 605B emit UV light that irradiates shaver heads 205A and 205B, and thus disinfects shaver heads 205A and 205B and surfaces in the vicinity of shaver heads 205A and 205B.

Circuit board 520 includes indicator lights 525 that are turned ON when UV light sources 605A and 605B are ON. Indicator lights 525 emit visible light that propagates through indicator light diffuser 515. Outer shell 510 includes an aperture 505 that accommodates indicator light diffuser 515, and through which the light from indicator lights 525 will further propagate. As such, light from indicator lights 525 is visible externally when UV light sources 605A and 605B are ON.

Contact bars 305A and 305B are situated along an external surface of inner shell 535, and at their tops, make contact with conductors on circuit board 520. As mentioned above, main body 110 includes a battery. The battery is a source of a voltage, e.g., 3.6 Vdc, and thus electric power, that is provided through spring-loaded contacts 310A and 310B and contact bars 305A and 305B to circuit board 520.

The configuration of cap 105 is easy to assemble, and keeps its components in place.

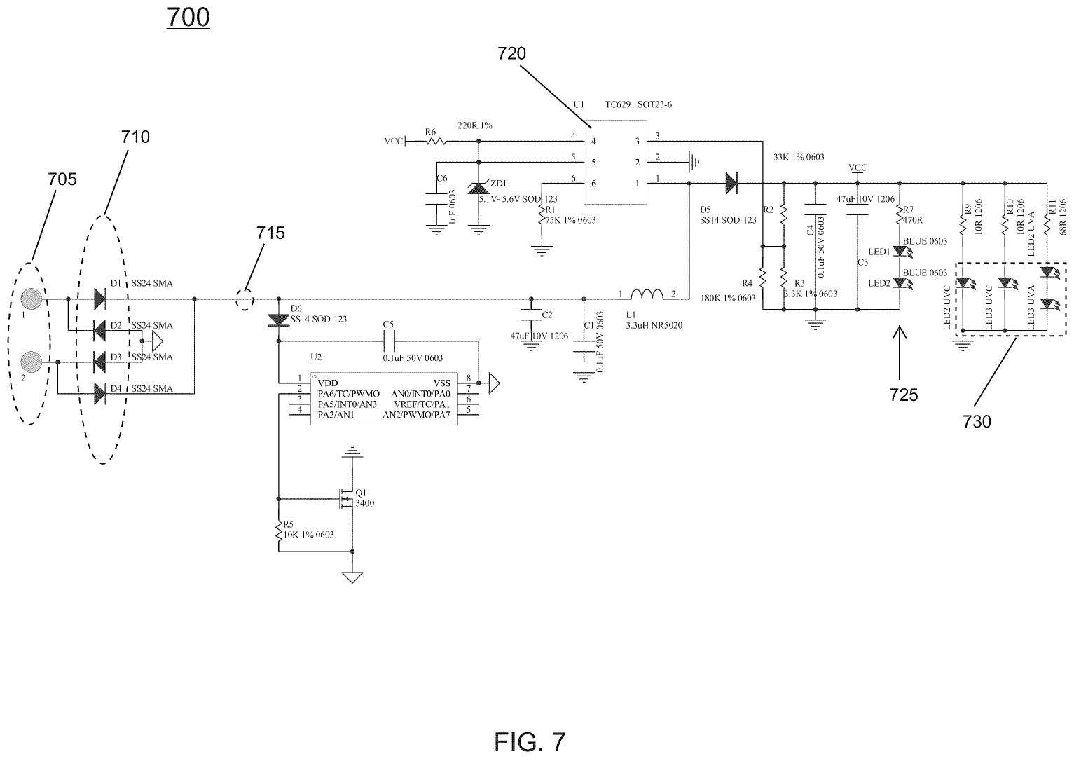

FIG. 7 is a schematic diagram of a circuit 700 that resides on circuit boards 520 and 530, and as such, circuit 700 is embodied in cap 105. Circuit 700 includes terminals 705 that receive a voltage from main body 110 via contact bars 305A and 305B. A diode bridge 710 that is configured with diodes D1, D2, D3 and D4, receives the voltage from terminals 705, and regardless of the polarity of the voltage on terminals 705, on a line 715 provides a voltage of proper polarity for utilization by other components of circuit 700. Thus, circuit 700 is operational when cap 105 is installed on main body 110, and non-operational when cap 105 is not installed on main body 110.

Although shaver 100 is described herein as having a plurality of UV light sources, i.e., UV light sources 605A and 605B, and a plurality of indicator lights 525, in practice, shaver 100 may include one or more UV light sources, and one or more indicator lights. In circuit 700, UV light sources 605A and 605B are represented by UV light-emitting diodes (LEDs) 730, and indicator lights 525 are represented by LEDs 725.

Circuit 700 also includes a timer 720 that controls a duration of time, i.e., a UV cycle, that UV LEDs 730, and thus UV light sources 605A and 605B, are ON. Similarly, timer 720 controls a duration of time that indicator lights 525 are ON. Timer 720 is activated, and thus begins the UV cycle, when cap 105 is installed on main body 110 and circuit 700 receives voltage from main body 110. The duration can be any desired duration, however, in practice, 3 minutes is an acceptable amount of time. Accordingly, when cap 105 is installed on main body 110, timer 720 is automatically activated, and thus begins the UV cycle for the duration of time that UV light sources 605A and 605B are ON, therefore the user does not have to press a button or do anything but put cap 105 on main body 110. Thus, the UV cycle is automatically started when cap 105 is installed on main body 110.

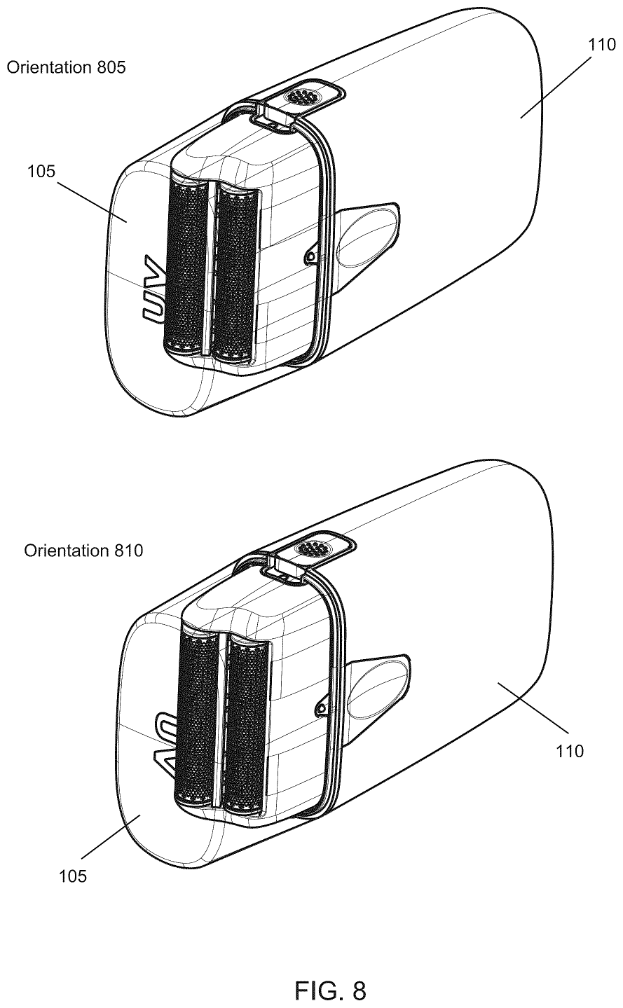

FIG. 8 is a diagram showing two examples of cap 105, in phantom lines, installed on main body 110. Cap 105 is reversible such that it can be installed as shown in orientation 805 or in orientation 810.

Recall that circuit 700 is embodied in cap 105. Diode bridge 710 rectifies the voltage presented on terminals 705, and regardless of the polarity of the voltage on terminals 705, provides a voltage of proper polarity on line 715 for utilization by other components of circuit 700. Thus, circuit 700 will function regardless of whether cap 105 is installed as shown in orientation 805 or in orientation 810. As such, a user of shaver 100 can install cap 105 onto main body 110 in either of orientation 805 or orientation 810.

Voltage, and thus electric power, is provided from main body 110 to circuit 700 when cap 105 is installed on main body 110. Conversely, voltage, and thus electric power, is removed from circuit 700 when cap 105 is removed from main body 110, thus ensuring that UV light sources 605A and 605B are OFF when cap 105 is not installed on main body 110. The removal of voltage from circuit 700 when cap 105 is removed from main body 110 is a safety feature that prevents a user's exposure to UV light from UV light sources 605A and 605B.

In summary, shaver 100 has main body 110 that includes shaver heads 205A and 205B, and a spring-loaded contacts 310A and 310B through which a first voltage is provided. Shaver 100 also has cap 105, which is installable on main body 110 in orientation 805 or orientation 810, and when installed on main body 110 covers shaver heads 205A and 205B. Cap 105 has contact bars 305A and 305B that engage spring-loaded contacts 310A and 310B when cap 105 is installed on main body 110, to receive the first voltage. Cap 105 also has circuit 700, which includes (i) diode bridge 710, which receives the first voltage via contact bars 305A and 305B, and provides a second voltage of proper polarity for utilization by other components of circuit 700, and (ii) UV light sources 605A and 605B, which utilize the second voltage, and when ON, emit UV light that irradiates shaver heads 205A and 205B.

Circuit 700 also includes timer 720, which utilizes second voltage and controls a duration of time that UV light sources 605A and 605B are ON.

Spring-loaded contacts 310A and 310B exert a mechanical force toward contact bars 305A and 305B when cap 105 is installed on main body 110. Spring-loaded contacts 310A and 310B are self-wiping.

Cap 105 also includes indicator lights 525 that are controlled by circuit 700 to emit visible light when UV light sources 605A and 605B are ON.

Cap 105 is configured with inner shell 535, and outer shell 510, which covers inner shell 535. Circuit 700 resides in a space between inner shell 535 and outer shell 510. Inner shell 535 is made of a non-conductive material, for example, plastic. Outer shell 510 is made of a metallic material, preferably metal for its weight and quality feel and preferably the whole shaver is metal on the outside.

Inner shell 535 separates all electrical conductors from outer shell 510.

While the present disclosure has been described with reference to one or more exemplary embodiments, it will be understood by those skilled in the art that various changes can be made and equivalents may be substituted for elements thereof without departing from the scope of the present disclosure. In addition, many modifications can be made to adapt a particular situation or material to the teachings of the disclosure without departing from the scope thereof. Therefore, it is intended that the present disclosure is not limited to the particular embodiment(s) disclosed as the best mode contemplated, but that the disclosure will include all embodiments falling within the scope of the appended claims.

The terms “comprises” or “comprising” are to be interpreted as specifying the presence of the stated features, integers, operations or components, but not precluding the presence of one or more other features, integers, operations or components or groups thereof. The terms “a” and “an” are indefinite articles, and as such, do not preclude embodiments having pluralities of articles.

### PARTS LIST

100 shaver
105 cap
110 main body
205A shaver head
205B shaver head
305A contact bar
305B contact bar
310A spring-loaded contact
310B spring-loaded contact
505 aperture
510 outer shell
515 indicator light diffuser
520 circuit board
525 indicator lights
530 circuit board
535 inner shell
540 apertures
605A UV light source
605B UV light source
700 circuit
705 terminals
710 diode bridge
715 line
720 timer
725 LEDs
730 UV LEDs
805 orientation
810 orientation

What is claimed is:

1. An electric shaver comprising:
a main body having:
a shaver head; and
a first pair of contacts through which a first voltage is provided from said main body;
a cap that is installable on said main body in a first orientation or a second orientation, and
when installed on said main body covers said shaver head, said cap having:
a second pair of contacts that engage said first pair of contacts when said cap is installed on said main body, to receive said first voltage; and
a circuit that includes:
a diode bridge that receives said first voltage via said second pair of contacts, and provides a second voltage of proper polarity for utilization by other components of said circuit; and
an ultraviolet (UV) light source that utilizes said second voltage, and when ON, emits UV light that irradiates said shaver head.

2. The electric shaver of claim 1, wherein said circuit also includes a timer that utilizes said second voltage.

3. The electric shaver of claim 2, wherein the timer controls a duration of time that said UV light source is ON.

4. The electric shaver of claim 3, wherein the timer is automatically activated, and thus begins a UV cycle for the duration of time that said UV light source is ON, when the cap is installed on the main body.

5. The electric shaver of claim 3, wherein said UV light source is OFF when the cap is removed from the main body based upon the second pair of contacts disengaging said first pair of contacts when said cap is removed from said main body.

6. The electric shaver of claim 1, wherein said first pair of contacts are spring-loaded contacts that exert a mechanical force toward said second pair of contacts when said cap is installed on said main body.

7. The electric shaver of claim 6, wherein said spring-loaded contacts are self-wiping.

8. The electric shaver of claim 1, wherein said cap also includes an indicator light that is controlled by said circuit.

9. The electric shaver of claim 8, wherein the indicator light emits visible light when said UV light source is ON.

10. The electric shaver of claim 1,
wherein said cap is configured with (a) an inner shell, and (b) an outer shell that covers said inner shell, and
wherein said circuit resides in a space between said inner shell and said outer shell.

11. The electric shaver of claim 10, wherein said inner shell is made of non-conductive material.

12. The electric shaver of claim 10, wherein said outer shell is made of a metallic material.
